(19) United States
(12) Patent Application Publication
(10) Pub. No.: US 2014/0335981 A1
(43) Pub. Date: Nov. 13, 2014

(54) PULLEY MECHANISM OF VEHICULAR BELT-TYPE CONTINUOUSLY VARIABLE TRANSMISSION

(71) Applicants: Masanori Kadokawa, Toyota-shi (JP); Yasuhiro Kawai, Toyota-shi (JP); Hirofumi Nakada, Toyota-shi (JP)

(72) Inventors: Masanori Kadokawa, Toyota-shi (JP); Yasuhiro Kawai, Toyota-shi (JP); Hirofumi Nakada, Toyota-shi (JP)

(73) Assignee: TOYOTA JIDOSHA KABUSHIKI KAISHA, Toyota-shi (JP)

(21) Appl. No.: 14/352,862

(22) PCT Filed: Oct. 21, 2011
(86) PCT No.: PCT/JP2011/074311

§ 371 Date: Apr. 18, 2014

(51) Int. Cl. F16H 9/18

(52) U.S. Cl. CPC F16H 9/18
USPC 474/8

(57) ABSTRACT

A pulley mechanism of a vehicular belt-type continuously variable transmission that makes it possible to enhance the joint strength between a rotary shaft and a stationary sheave without increasing the axial length of the belt-type continuously variable transmission is provided. Since a first stationary portion and a second stationary portion are provided on both sides of a step portion respectively, a stationary sheave is fixed by this first stationary portion and this second stationary portion, and the joint strength between the stationary sheave and an output shaft increases. Besides, a belt reaction force during power transmission can be received by the first stationary portion and the second stationary portion. Therefore, the amount of inclination of the stationary sheave during power transmission is also held small, and a fall in the torque capacity and transmission efficiency of the belt-type continuously variable transmission and a deterioration in the NV characteristics of the belt-type continuously variable transmission can be suppressed.

### TECHNICAL FIELD

The invention relates to a pulley mechanism of a vehicular belt-type continuously variable transmission, and more particularly, to the structure of sheaves that constitute the pulley mechanism.

### BACKGROUND ART

A vehicular belt-type continuously variable transmission that is equipped with a pair of pulleys that are configured to include a stationary sheave that is fixed to a rotary shaft that penetrates an inner peripheral portion thereof and a movable sheave that is non-rotatable relatively to the rotary shaft and movable in an axial direction, and a transmission belt that is wound around the pair of the pulleys is well-known. For instance, a belt-type continuously variable transmission described in Patent Document 1 is such an example.

In the belt-type continuously variable transmission of Patent Document 1, there is disclosed an art in which a stationary sheave and an input shaft (a rotary shaft) are configured separately from each other, and the stationary sheave and a movable sheave are configured as a common component to achieve the enhancement of productivity.

### RELATED ART DOCUMENT

### Patent Document

Patent Document 1: Japanese Patent Application Publication No. 2009-204093 (JP-2009-204093 A)

### SUMMARY OF THE INVENTION

### Problems to Be Solved by the Invention

By the way, in the belt-type continuously variable transmission of Patent Document 1, as shown in FIGS. 1 to 4 of the cited document 1, step portions that abut on each other to receive a load in a thrust direction are provided respectively between an inner peripheral portion of the stationary sheave and an outer peripheral portion of the rotary shaft. The step portion on a large-diameter portion side is spline-fitted, so that the stationary sheave and the input shaft are prevented from rotating relatively to each other. However, nothing is specified about a more detailed structure for attaching the stationary sheave and the rotary shaft to each other. For example, in an attachment structure for the stationary sheave of Patent Document 1, in the case where only a small-diameter portion side that is formed by a stepped portion is press-fitted, the press-fitted region has a short axial length (a short press-fitting span). Therefore, the joint strength between the rotary shaft and the stationary sheave falls. When the stationary sheave receives a belt reaction force of a transmission belt during torque transmission, the amount of inclination of the stationary sheave increases. Thus, the transmission belt is also inclined in the same manner, which results in a problem of a fall in the torque capacity and transmission efficiency of the belt-type continuously variable transmission, and also a problem of a deterioration in the NV characteristics of the belt-type continuously variable transmission.

Besides, if the amount of inclination of the stationary sheave increases, the stationary sheave is pressed against the rotary shaft, so that a load is applied in such a direction as to bend the rotary shaft. In particular, however, in the case where the stepped portion is formed as in the cited document 1, stress concentration is likely to occur in that region. Therefore, a measure needs to be taken to suppress this stress concentration. In contrast, if the press-fitting span is increased, the joint strength increases, and hence these problems are solved. However, there is caused a problem of an increased axial length of the belt-type continuously variable transmission. Incidentally, this problem arises in the same manner even in the case where the large-diameter portion side of the stepped portion is press-fitted.

The invention has been made in view of the foregoing circumstances. It is an object of the invention to provide a pulley mechanism of a vehicular belt-type continuously variable transmission that includes a stationary sheave that is fixed to a rotary shaft and a movable sheave that is non-rotatable relatively to the rotary shaft and movable relatively in an axial direction with the rotary shaft and the stationary sheave configured separately from each other, and that can suppress a fall in torque capacity and transmission efficiency and a deterioration in NV characteristics by enhancing the joint strength between the rotary shaft and the stationary sheave without increasing the axial length of the belt-type continuously variable transmission.

### Means for Solving the Problems

The gist of the invention according to claim 1 for achieving the aforementioned object consists in a pulley mechanism of a vehicular belt-type continuously variable transmission that includes (a) a stationary sheave that is securely fitted to a rotary shaft that penetrates an inner peripheral portion thereof, and a movable sheave that is non-rotatable relatively to the rotary shaft and movable relatively in an axial direction, with the rotary shaft and the stationary sheave configured separately from each other. The pulley mechanism of the vehicular belt-type continuously variable transmission is characterized in that (b) step portions for receiving a load in the axial direction are formed respectively between an outer peripheral portion of the rotary shaft and the inner peripheral portion of the stationary sheave, and a first stationary portion and a second stationary portion that fix the rotary shaft and the stationary shaft to each other are provided on both sides of the step portions in the axial direction respectively.

### Effects of the Invention

In this manner, the first stationary portion and the second stationary portion, which fix the rotary shaft and the stationary sheave to each other, are provided on both the sides of the step portions in the axial direction respectively. Therefore, the stationary sheave is fixed by this first stationary portion and this second stationary portion, and the joint strength between the stationary sheave and the rotary shaft increases. Besides, a belt reaction force during power transmission can be received by the first stationary portion and the second stationary portion. Therefore, the amount of inclination of the stationary sheave during power transmission is also held small, and a fall in the torque capacity and transmission efficiency of the belt-type continuously variable transmission and a deterioration in the NV characteristics of the belt-type continuously variable transmission can be suppressed. Besides, the step portion that is formed on the rotary shaft side is sandwiched in the axial direction by the first stationary portion and the second stationary portion. Therefore, the belt reaction force is received by the first stationary portion and the second stationary portion, so that a load in a bending direction is unlikely to be input to the vicinity of the step portion of the rotary shaft, and a problem of stress concentration caused at the step portions is also solved.

Besides, preferably, the first stationary portion and the second stationary portion are fixed through press-fitting. In this manner, the joint strength between the rotary shaft and the stationary sheave is enhanced, and the belt reaction force is received by a press-fitted portion of the first stationary portion and a press-fitted portion of the second stationary portion. Therefore, the amount of inclination of the stationary sheave during power transmission is also held small, and a fall in torque capacity and transmission efficiency and a deterioration in NV characteristics can be suppressed. Besides, the rotary shaft and the stationary sheave are fixed to each other through press-fitting at two locations, namely, the first stationary portion and the second stationary portion. Therefore, as the press-fitted portions are ensured of a sufficient area, the axial length of the belt-type continuously variable transmission is also restrained from being increased to secure an area of the press-fitted regions.

Besides, preferably, spline teeth that mesh with each other are formed on at least one of the first stationary portion and the second stationary portion, and the spline teeth are press-fitted to each other. In this manner, the rotary shaft and the stationary sheave are reliably prevented from rotating relatively to each other. Therefore, a fall in transmission efficiency is further suppressed.

Besides, preferably, the first stationary portion and the second stationary portion are fixed through welding. In this mariner, the joint strength between the rotary shaft and the stationary sheave is enhanced. The belt reaction force is received by a welded portion of the first stationary portion and a welded portion of the second stationary portion. Therefore, the amount of inclination of the stationary sheave during power transmission is also held small, and a fall in torque capacity and transmission efficiency and a deterioration in NV characteristics can be suppressed.

Besides, preferably, a gap is formed in a corner portion of at least one of the step portions that are formed on the rotary shaft and the stationary sheave. In this manner, the stationary sheave can be securely fitted to the rotary shaft without hitch.

### BRIEF DESCRIPTION OF THE DRAWINGS

FIG. 1 is a skeleton view of a vehicular power transmission device to which the invention is preferably applied.

FIG. 2 is a cross-sectional view showing part of the vehicular power transmission device of FIG. 1, and more particularly, is a cross-sectional view showing a structure around a secondary pulley.

FIG. 3 is a partially enlarged view of FIG. 2, and more particularly, is a cross-sectional view for illustrating a mechanism in which a stationary sheave is fixed to an output shaft.

FIG. 4 is a cross-sectional view for illustrating a mechanism in which a stationary sheave is fixed to an output shaft as another embodiment of the invention.

FIG. 5 is a cross-sectional view for illustrating a mechanism in which a stationary sheave is fixed to an output shaft as still another embodiment of the invention.

### MODES FOR CARRYING OUT THE INVENTION

The embodiments of the invention will be described hereinafter in detail with reference to the drawings. Incidentally, in the following embodiments of the invention, the drawings are appropriately simplified or modified, and the dimensional ratios, shapes and the like of respective portions are not necessarily depicted with precision.

### First Embodiment

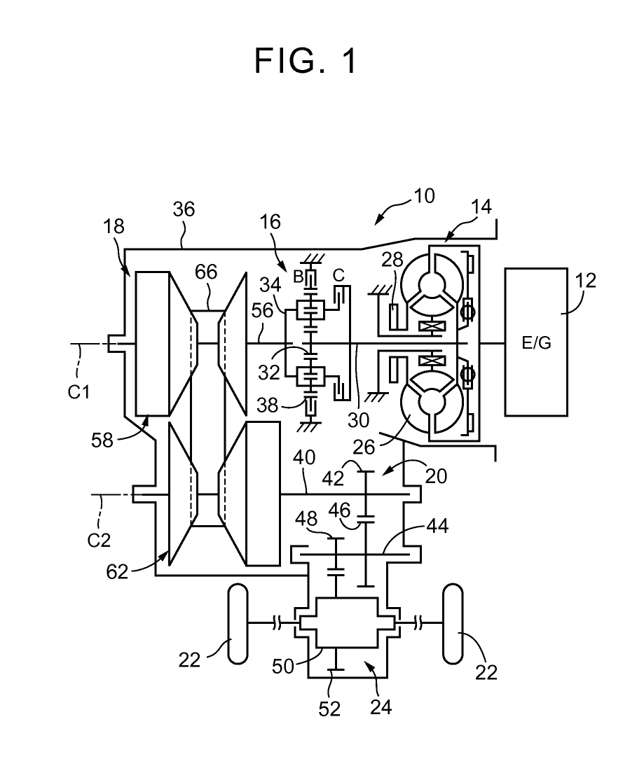

FIG. 1 is a skeleton view of a vehicular power transmission device 10 to which the invention is preferably applied. In FIG. 1, the vehicular power transmission device 10 is designed for a front-engine, front-drive (FF) vehicle, and is coupled to an engine 12 that is well-known as a drive source for a vehicle. This vehicular power transmission device 10 is equipped with a torque converter 14 that is well-known as a hydraulic power transmission that transmits a torque of the engine 12 through the intermediary of a fluid, a forward/backward changeover device 16 that changes over the rotational direction of the torque transmitted from the torque converter 14 between a rotational direction for forward traveling of the vehicle and a reverse rotational direction for backward traveling of the vehicle as the opposite direction, a vehicular belt-type continuously variable transmission (hereinafter referred to as the continuously variable transmission) 18 that converts the torque transmitted via the forward/backward changeover device 16 into a torque corresponding to a load, a reduction gear unit 20 that is coupled to an output side of the continuously variable transmission 18, and a well-known so-called bevel gear-type differential gear unit 24 that transmits the torque transmitted via the reduction gear unit 20 to a pair of right and left wheels 22 while allowing a rotational difference therebetween. A pump impeller 26 of the aforementioned torque converter 14 is provided with a mechanical oil pump 28 that generates an oil pressure or the like to be used, for example, in shift control of the continuously variable transmission 18 or forward/backward changeover control of the forward/backward changeover device 16.

The aforementioned forward/backward changeover device 16 is mainly constituted of a double pinion-type planetary gear unit that includes a sun gear 32 that is coupled to a turbine shaft 30 of the torque converter 14, a carrier 34 that is coupled to an input shaft 56 of the continuously variable transmission 18 and is selectively coupled to the turbine shaft 30 via a forward clutch C, and a ring gear 38 that is selectively coupled to a transaxle case 36 (hereinafter referred to as the case 36) as a non-rotary member via a backward brake B. Both the aforementioned forward clutch C and the aforementioned backward brake B are hydraulic frictional engagement devices that are frictionally engaged by being supplied with an oil pressure from the oil pump 28. In this forward/backward changeover device 16, the forward clutch C is engaged, and the backward brake B is released, so that the planetary gear unit assumes an integral rotation state to establish a forward power transmission path. In the case where the aforementioned forward power transmission path is established, the torque transmitted from the torque converter 14 is output to the continuously variable transmission 18 in its original rotational direction. Besides, in the forward/backward changeover device 16, the backward brake B is engaged and the forward clutch C is released, so that the planetary gear unit assumes an input/output reverse rotation state to establish a backward power transmission path. In the case where the aforementioned backward power transmission path is established, the torque transmitted from the torque converter 14 is output to the continuously variable transmission 18 in a direction reverse to its original rotational direction. Besides, when both the forward clutch C and the backward brake B are released, the forward/backward changeover device 16 assumes a neutral state (a shutoff state) in which the transmission of power is shut off.

The continuously variable transmission 18 is equipped with a primary pulley (an input-side variable groove width pulley) 58 that is provided on an outer peripheral side of the input shaft 56 and can rotate around an axis C1, a secondary pulley (an output-side variable groove width pulley) 62 that is provided on an outer peripheral side of the output shaft 40 parallel to the input shaft 56 and can rotate around an axis C2, and a well-known endless annular transmission belt 66 that is wound around between the primary pulley 58 and the secondary pulley 62 to transmit power between both the pulleys through a frictional force. In the belt-type continuously variable transmission 18 configured as described above, a pulley groove of the primary pulley 58 and a pulley groove of the secondary pulley 62 are changed to change the winding radii of the primary pulley 58 and the secondary pulley 62 of the transmission belt 66 respectively, so that the speed ratio (the rotational speed of the input shaft 56/the rotational speed of the output shaft 40) changes steplessly. If the winding radius of the primary pulley 58 of the transmission belt 66 is reduced and the winding radius of the secondary pulley 62 of the transmission belt 66 is increased, a speed ratio y of the belt-type continuously variable transmission 18 increases. Besides, if the winding radius of the primary pulley 58 of the transmission belt 66 is increased and the winding radius of the secondary pulley 62 of the transmission belt 66 is reduced, the speed ratio of the belt-type continuously variable transmission 18 decreases.

The reduction gear unit 20 is equipped with a first drive gear 42 that is relatively non-rotatably fitted to an outer peripheral face of the output shaft 40 of the continuously variable transmission 18, a transmission shaft 44 that is provided parallel to the output shaft 40 and is rotatably supported, a first driven gear 46 that is relatively non-rotatably fitted to an outer peripheral face of the transmission shaft 44 and is meshed with the first drive gear 42, a second drive gear 48 that is, protrusively provided from the outer peripheral face of the transmission shaft 44 toward an outer peripheral side, and a second driven gear (a differential ring gear) 52 that is relatively non-rotatably fitted to an outer peripheral face of a differential case 50 of the differential gear unit 24, which is provided parallel to the transmission shaft 44 and is rotatably supported, and is meshed with the second drive gear 48. The aforementioned first drive gear 42 and the aforementioned second drive gear 48 are formed with a diameter smaller than the aforementioned first driven gear 46 and the aforementioned second driven gear 52 respectively. In this reduction gear unit 20, during acceleration of the vehicle, a torque transmitted from the output shaft 40 of the continuously variable transmission 18 to the first drive gear 42 is output to the differential case 50 of the differential gear unit 24 via the first driven gear 46, the transmission shaft 44, the second drive gear 48, and the second driven gear 52. Besides, during deceleration of the vehicle, a reverse driving force that is transmitted from the pair of the right and left wheels 22 is transmitted to the output shaft 40 of the continuously variable transmission 18 via the differential gear unit 24 and the reduction gear unit 20.

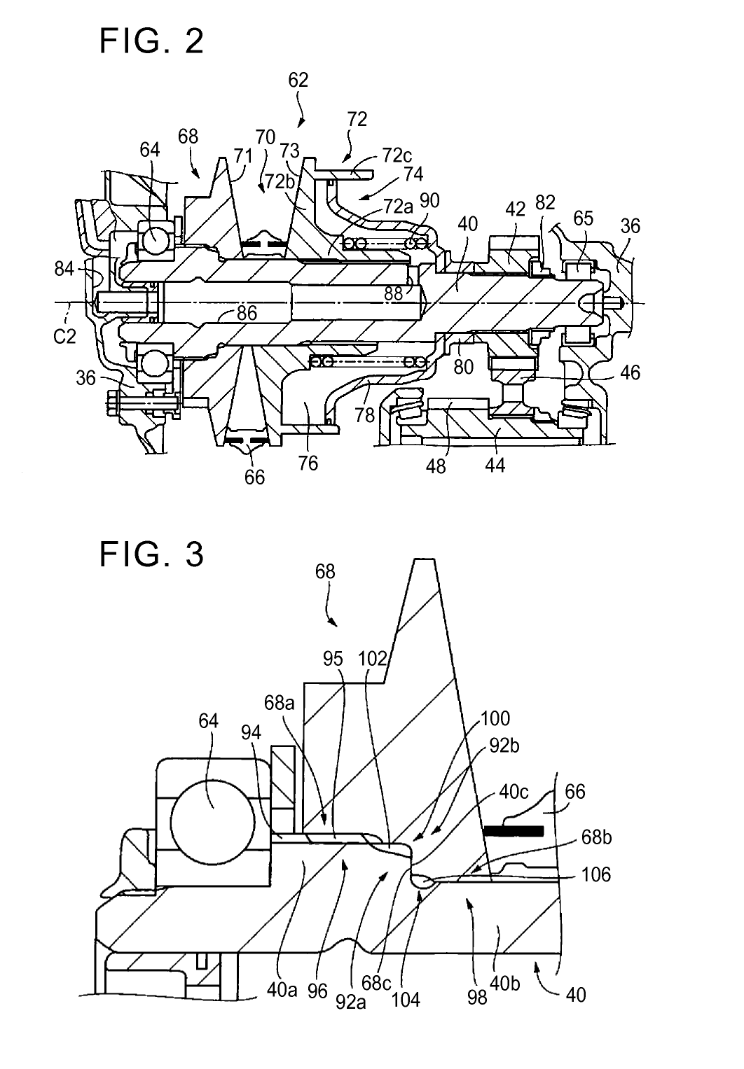

FIG. 2 is a cross-sectional view showing part of the vehicular power transmission device 10 shown in FIG. 1, and more particularly, is a cross-sectional view showing a structure around the secondary pulley 62. As shown in FIG. 2, the secondary pulley 62 is provided on the outer peripheral side of the output shaft 40. Incidentally, the output shaft 40 corresponds to the rotary shaft of the invention, and the secondary pulley 62 corresponds to the pulley mechanism of the invention.

The output shaft 40 is supported by the case 36 rotatably around the axis C2, via bearings 64 and 65 that are provided on both outer peripheral ends in the axial direction respectively. The secondary pulley 62 is equipped with a stationary sheave 68 that is securely fitted to the outer peripheral side of the output shaft 40, a movable sheave 72 that is spline-fitted to the output shaft 40 relatively non-rotatably and movably in the axial direction in such a manner as to form a V-shaped pulley groove 70 between the movable sheave 72 and the stationary sheave 68, and a hydraulic actuator 74 that changes the groove width of the pulley groove 70 by moving the movable sheave 72 in the axial direction in accordance with a supplied oil pressure to move the stationary sheave 68 and the movable sheave 72 toward each other or away from each other.

The stationary sheave 68 is an annular member that is securely fitted to the output shaft 40 that penetrates an inner peripheral portion thereof. A conical sheave face 71 for forming the pulley groove 70 is formed on the movable sheave 72 side in the axial direction of the stationary sheave 68. In this embodiment of the invention, the output shaft 40 and the stationary sheave 68 are not molded integrally with each other, and are configured separately from each other. If they are thus configured separately from each other, there is no large-diameter region in forming the output shaft 40 through forging. Therefore, the yield during molding is also improved, and the cost of a thermal treatment during hot forging is also reduced. Incidentally, a mechanism that fixes the stationary sheave 68 to the output shaft 40 will be described later.

The movable sheave 72 is spline-fitted to the output shaft 40 movably in the axial direction and relatively non-rotatably around the axis C2. The movable sheave 72 is equipped with an inner tube portion 72a whose inner peripheral portion is spline-fitted to the output shaft 40, a disc-like disc portion 72b that protrudes from an end on the stationary sheave 68 side toward the outer peripheral side in the axial direction of the inner tube portion 72a, and a cylindrical outer tube portion 72c that extends from an outer peripheral portion of the disc portion 72b to the other side of the stationary sheave 68 in the axial direction. A conical sheave face 73 for forming the pulley groove 70 is formed on the disc portion 72b. The V-shaped pulley groove 70 is formed by the aforementioned sheave face 73 and the aforementioned sheave face 71.

The hydraulic actuator 74 is provided adjacently to the movable sheave 72 on the other side of the stationary sheave 68 in the axial direction of the movable sheave 72. The hydraulic actuator 74 is equipped with a bottomed cylinder-like cylinder member 78 for forming an oil-tight hydraulic chamber 76 together with the movable sheave 72 and the output shaft 40. An inner peripheral portion of the cylinder member 78 is sandwiched between a stepped face formed on the output shaft and a spacer 80, so that the cylinder member 78 is prevented from moving in the axial direction. Incidentally, the spacer 80 is pressed against the cylinder member 78 via the first drive gear 42 whose inner peripheral portion is spline-fitted to the output shaft 40, by a nut 82 that is fastened to the output shaft 40. Besides, an outer peripheral end of the cylinder member 78 is in slidable contact with an inner peripheral face of the outer tube portion 72c. Incidentally, an oil seal is fitted to the outer peripheral end of the cylinder member 78, so that a slidable contact face with the outer tube portion 72c is oil-tight.

This cylinder member 78, this movable sheave 72, and this output shaft 40 form the hydraulic chamber 76 as an oil-tight annular space. Hydraulic oil is supplied to the hydraulic chamber 76 through a case oil passage 84 that is formed in the case 36, an axial oil passage 86 that is formed inside the output shaft 40 parallel to the axis C2 and communicates with the case oil passage 84, and a radial oil passage 88 that radially penetrates the output shaft 40 from the axial oil passage 86 and communicates with the hydraulic chamber 76. The pressure of this hydraulic oil is appropriately adjusted by a hydraulic control circuit (not shown), on the assumption that the pressure of oil discharged from the oil pump 28 is an original pressure. Besides, a coil spring 90 that urges the movable sheave 72 toward the stationary sheave 68 side is interposed between a stepped end face that is formed at an outer peripheral portion of the inner tube portion 72a of the movable sheave 72 and a wall face on an inner peripheral side of the cylinder member 78.

In the secondary pulley 62 configured as described above, a thrust toward the stationary sheave 68 side, namely, a thrust in such a direction as to clamp the transmission belt 66 is applied to the movable sheave 72 in accordance with the oil pressure that is supplied to the hydraulic chamber 76. In FIG. 2, the secondary pulley 62 that is indicated by a solid line below the axis C1 represents a state where the pulley groove 70 that is formed between the stationary sheave 68 and the movable sheave 72 has a minimum groove width Wmin. In this state, the winding radius of the transmission belt 66 on the secondary pulley 62 is maximized, and the speed ratio of the belt-type continuously variable transmission 18 is a maximum speed ratio γmax. Besides, the secondary pulley 62 that is indicated by a solid line above the axis C1 represents a state where the pulley groove 70 that is formed between the stationary sheave 68 and the movable sheave 72 has a minimum groove width Wmax. In this state, the winding radius of the transmission belt 66 on the secondary pulley 62 is minimized, and the speed ratio γ of the belt-type continuously variable transmission 18 is a minimum speed ratio γmin.

FIG. 3 is a partially enlarged view of FIG. 2, and more particularly, is a cross-sectional view for illustrating a mechanism in which the stationary sheave 68 is fixed to the output shaft 40. As shown in FIG. 3, the output shaft 40 penetrates an inner peripheral portion of the stationary sheave 68, and the stationary sheave 68 is securely fitted to an outer peripheral portion of the output shaft 40 relatively non-rotatably and immovably in the axial direction.

A step portion 92a is formed at the outer peripheral portion of the output shaft 40, so that a large-diameter shaft portion 40a and a small-diameter shaft portion 40b are formed. Besides, a step portion 92b that can be fitted to the step portion 92a is formed at the inner peripheral portion of the stationary sheave 68 as well, so that a large-diameter inner peripheral portion 68a and a small-diameter inner peripheral portion 68b are formed. Besides, a wall face 40c that is formed by the step portion 92a of the output shaft 40 and is perpendicular to the axis, and a wall face 68c that is formed by the step portion 92b of the stationary sheave 68 and is perpendicular to the axis are held in abutment on each other, and mutually receive a load in the axial direction (a thrust direction). This wall face 40c and this wall face 68c also function as stoppers for preventing the stationary sheave 68 from moving toward the bearing 64 side.

Besides, outer peripheral teeth 94 (spline teeth) are formed on an outer peripheral face of the large-diameter shaft portion 40a of the output shaft 40, and inner peripheral teeth 95 (spline teeth) that mesh with the outer peripheral teeth 94 are formed at the large-diameter inner peripheral portion 68a of the stationary sheave 68 as well. These spline teeth 95 and 96 are press-fitted to each other respectively. More specifically, at the large-diameter shaft portion 40a and the large-diameter inner peripheral portion 68a, fixation occurs through so-called spline large-diameter tooth flank press-fitting (hereinafter referred to as spline press-fitting) in which tooth flanks of tooth tips and tooth addendums of the outer peripheral teeth 94 on the large-diameter side and tooth flanks of tooth bottoms and tooth roots of the inner peripheral teeth 95 are press-fitted to each other respectively. Owing to this spline press-fitting, the joint strength between the output shaft 40 and the stationary sheave 68 is enhanced, and also, the output shaft 40 and the stationary sheave 68 are reliably prevented from rotating relatively to each other. In this embodiment of the invention, a stationary portion resulting from the spline press-fitting of this large-diameter shaft portion 40a and this large-diameter inner peripheral portion 68a is defined as a first stationary portion 96.

Besides, an outer peripheral portion of the small-diameter shaft portion 40b of the output shaft 40 and an inner peripheral portion of the small-diameter inner peripheral portion 68b of the stationary sheave 68 are fixed by being press-fitted (hereinafter referred to as cylinder press-fitting so as to make a distinction from spline press-fitting) on cylinder faces thereof. In this embodiment of the invention, a stationary portion resulting from the cylinder press-fitting of this small-diameter shaft portion 40b and this small-diameter inner peripheral portion 68b is defined as a second stationary portion 98. Accordingly, as shown in FIG. 3, on both sides of the step portion 92a and the step portion 92b (hereinafter referred to as a step portion 92 if no distinction is made therebetween in particular) in the axial direction, the first stationary portion 96 and the second stationary portion 98 are provided respectively in such a manner as to sandwich the step portion 92 in the axial direction.

An annular gap 102 is formed at a corner portion 100 of the step portion 92 on the large-diameter side. As shown in, for example, FIG. 3, a notch is annularly formed at an end of the output shaft 40 on the large-diameter shaft portion 40a side, so that the annular gap 102 is formed. Incidentally, this gap 102 may be formed by providing the end of the stationary sheave 68 on the large-diameter inner peripheral portion 68a side with a notch, or providing both the ends of the stationary sheave 68 with notches.

An annular gap 106 is formed at a corner portion 104 of the step portion 92 on the small-diameter side. As shown in, for example, FIG. 3, a notch is annularly formed at an end of the output shaft 40 on the small-diameter shaft portion 40b side, and a notch is formed also at an end of the stationary sheave 68 on the small-diameter inner peripheral portion 68b side, so that the gap 106 is formed. Incidentally, as long as the gap 106 is formed, a notch may be formed at at least one of the end of the output shaft 40 on the small-diameter shaft portion 40b side and the end of the stationary sheave 68 on the small-diameter inner peripheral portion 68b side.

An operation and an effect resulting from fixation of the stationary sheave 68 to the output shaft 40 as described above will be described. If the vehicle is driven, a belt reaction force that is generated through the clamping of the transmission belt 66 by the stationary sheave 68 and the movable sheave 72 is transmitted to the stationary sheave 68 as well, and is applied in such a direction as to incline the stationary sheave 68. In contrast, the first stationary portion 96, which is spline press-fitted, and the second stationary portion 98, which is cylinder press-fitted, are provided on both the sides of the step portion 92 in the axial direction respectively, in such a manner as to sandwich the step portion 92. Therefore, the stationary sheave 68 is fixed to the output shaft 40 at two locations, and the joint strength between the output shaft 40 and the stationary sheave 68 is enhanced. Accordingly, the amount of inclination of the stationary sheave 68 resulting from the belt reaction force is held small, and a fall in the torque capacity and transmission efficiency of the belt-type continuously variable transmission 18 and a deterioration in the NV performance of the belt-type continuously variable transmission 18, which are ascribable to inclination of the stationary sheave 68, are also suppressed. Besides, since press-fitting (spline press-fitting and cylinder press-fitting) occurs at both the first stationary portion 96 and the second stationary portion 98, the press-fitted regions can be ensured of a sufficient area as well, without increasing the axial lengths of the output shaft 40 and the stationary sheave 68.

Besides, the belt reaction force that is transmitted to the stationary sheave 68 is also transmitted to the output shaft 40, and is applied perpendicularly to the axis of the output shaft 40 (a bending load). This load causes a problem in that stress concentration occurs at the step portion 92a (the corner portion 104) of the output shaft 40. However; in this embodiment of the invention, since the step portion 92a is sandwiched by the first stationary portion 96 and the second stationary portion 98, the first stationary portion 96 and the second stationary portion 98 receive and hold this belt reaction force. As a result, the bending load is unlikely to be input to this step portion 92a, which is sandwiched by the first stationary portion 96 and the second stationary portion 98. Accordingly, stress concentration is also restrained from being caused at the step portion 92a of the output shaft 40.

Besides, the gaps 102 and 106 are formed at the corner portion 100 and the corner portion 104 respectively, so that the stationary sheave 68 can be securely fitted to the output shaft 40 without hitch when being press-fitted thereinto. Besides, stress concentration is also suppressed through formation of the gap 106.

As described above, according to this embodiment of the invention, the first stationary portion 96 and the second stationary portion 98, which fix the output shaft 40 and the stationary sheave 68 to each other, are provided on both the sides of the step portion 92 in the axial direction respectively. Therefore, the stationary sheave 68 is fixed by this first stationary portion 96 and this second stationary portion 98, and the joint strength between the stationary sheave 68 and the output shaft 40 increases. Besides, the belt reaction force during power transmission can be received by the first stationary portion 96 and the second stationary portion 98. Therefore, the amount of inclination of the stationary sheave 68 during power transmission is also held small, and a fall in the torque capacity and transmission efficiency of the belt-type continuously variable transmission 18 and a deterioration in the NV characteristics of the belt-type continuously variable transmission 18 can be suppressed. Besides, the step portion 92 that is formed on the output shaft 40 side is sandwiched in the axial direction by the first stationary portion 96 and the second stationary portion 98. Therefore, the first stationary portion 96 and the second stationary portion 98 receive the belt reaction force, so that a load in a bending direction is unlikely to be input to the vicinity of the step portion 92a of the output shaft 40, and the problem of stress concentration caused at the step portion 92a is also solved.

Besides, according to this embodiment of the invention, the first stationary portion 96 and the second stationary portion 98 are fixed through press-fitting (spline press-fitting and cylinder press-fitting). In this manner, the joint strength between the output shaft 40 and the stationary sheave 68 is enhanced, and the belt reaction force is received through spline press-fitting of the first stationary portion 96 and cylinder press-fitting of the second stationary portion 98. Therefore, the amount of inclination of the stationary sheave 68 during power transmission is also held small, and a fall in torque capacity and transmission efficiency and a deterioration in NV characteristics can be suppressed. Besides, the output shaft 40 and the stationary sheave 68 are fixed to each other through press-fitting at two locations, namely, the first stationary portion 96 and the second stationary portion 98. Therefore, the axial length of the belt-type continuously variable transmission 18 is also restrained from being increased to ensure the press-fitted regions, as the press-fitted area is sufficiently ensured.

Besides, according to this embodiment of the invention; the first stationary portion 98 is spline press-fitted. Therefore, the output shaft 40 and the stationary sheave 68 are reliably prevented from sliding with respect to each other, and hence a fall in transmission efficiency is further suppressed.

Besides, according to this embodiment of the invention, the gaps 102 and 106 are formed at the corner portions 100 and 104 of the step portion 92, which is formed on the output shaft 40 and the stationary sheave 68, respectively. In this manner, the stationary sheave 68 can be securely fitted to the output shaft 40 without hitch.

Next, other embodiments of the invention will be described. Incidentally, those components which are common to the foregoing embodiment of the invention will be denoted by the same reference symbols respectively in the following description, and the description of those components will be omitted.

### Second Embodiment

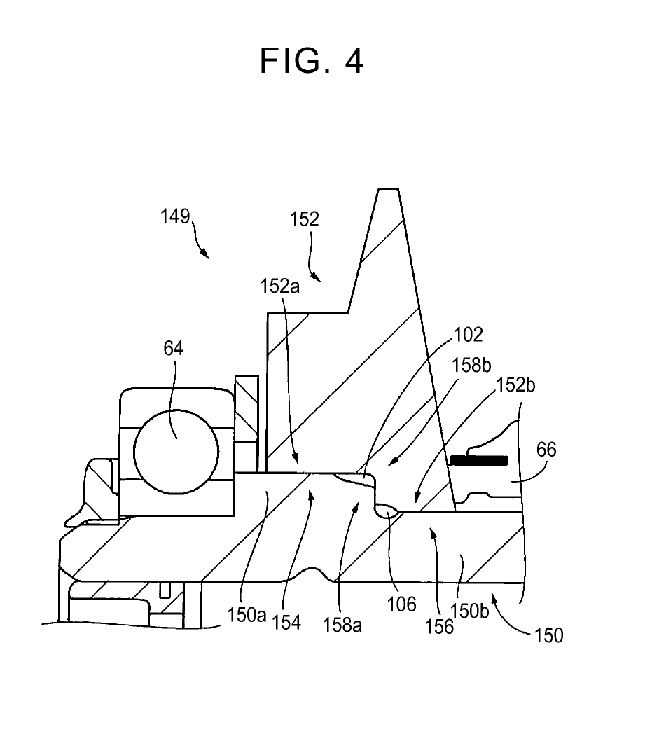

FIG. 4 is a cross-sectional view for illustrating a structure in which a stationary sheave 152 is fixed to an output shaft 150 in a secondary pulley 149 as another embodiment of the invention. If the secondary pulley 149 according to this embodiment of the invention is compared with that of the foregoing embodiment of the invention, a first stationary portion 154 as a stationary portion of a large-diameter shaft portion 150a of the output shaft 150 and a large-diameter inner peripheral portion 152a of the stationary sheave 152 is fixed through cylinder press-fitting. Incidentally, other configurational details are the same as in the foregoing embodiment of the invention, and hence the description thereof will be omitted. The output shaft 150 according to this embodiment of the invention corresponds to the rotary shaft according to the invention, and the secondary pulley 149 corresponds to the pulley mechanism according to the invention.

A step portion 158a is formed at an outer peripheral portion of the output shaft 150, so that a large-diameter shaft portion 150a and a small-diameter shaft portion 150b are formed. Besides, a step portion 158b that is fitted to a step portion 158a is formed also at an inner peripheral portion of the stationary sheave 152, so that a large-diameter inner peripheral portion 152a and a small-diameter inner peripheral portion 152b are formed. Then, the large-diameter shaft portion 150a and the large-diameter inner peripheral portion 152a are fixed through cylinder press-fitting, and the small-diameter shaft portion 150b and the small-diameter inner peripheral portion 152b are fixed through cylinder press-fitting. In this embodiment of the invention, a cylinder press-fitting portion (a stationary portion) of the large-diameter shaft portion 150a and the large-diameter inner peripheral portion 152a corresponds to the first stationary portion 154, and a cylinder press-fitting portion (a stationary portion) of the, small-diameter shaft portion 150b and the small-diameter inner peripheral portion 152b corresponds to the second stationary portion 156. Accordingly, in this embodiment of the invention as well, the first stationary portion 154 and the second stationary portion 156 are provided on both sides of the step portions (158a and 158b) in the axial direction respectively, in such a manner as to sandwich the step portion 158.

In this manner, even in the case where the first stationary portion 154 is fixed through cylinder press-fitting, an effect substantially similar to that of the foregoing embodiment of the invention can be obtained. That is, since both the first stationary portion 154 and the second stationary portion 156 are fixed through cylinder press-fitting, the joint strength between the output shaft 150 and the stationary sheave 152 is enhanced, and the amount of inclination of the stationary sheave 152 by a belt reaction force is held small. Accordingly, a fall in torque capacity and transmission efficiency and a deterioration in NV performance, which are ascribable to inclination of the stationary sheave 152, are also suppressed. Besides, since cylinder press-fitting occurs at both the first stationary portion 154 and the second stationary portion 156, the press-fitted regions are also ensured of an area without increasing the axial lengths of the output shaft 150 and the stationary sheave 152. Besides, the first stationary portion 154 and the second stationary portion 156 receive and hold this belt reaction force, and a bending load resulting from the belt reaction force is unlikely to be input to the step portion 158 of the output shaft 150, which is sandwiched by the first stationary portion 154 and the second stationary portion 156. Accordingly, stress concentration is also restrained from being caused at the step portion 158a of the output shaft 150.

In the foregoing embodiment of the invention, the output shaft 40 and the stationary sheave 68 are prevented from rotating relatively to each other through spline fitting. In this embodiment of the invention, however, since no spline-fitted portion is provided, the output shaft 150 and the stationary sheave 152 slip with respect to each other to create a possibility of a fall in transmission efficiency or the like. However, since an entire circumferential face of the first stationary portion 154 is press-fitted, the press-fitting area is larger than in the case of spline press-fitting in which only large-diameter portions of tooth flanks are press-fitted as is the case with the foregoing embodiment of the invention. Therefore, a sufficient joint strength can be obtained, and almost no slippage is caused.

As described above, in this embodiment of the invention, the first stationary portion 154 and the second stationary portion 156 are fixed respectively through cylinder press-fitting. In this manner, the joint strength between the output shaft 150 and the stationary sheave 152 is enhanced, and the belt reaction force is received by the first stationary portion 154 and the second stationary portion 156. Therefore, the amount of inclination of the stationary sheave 152 during power transmission is also held small, and a fall in torque capacity and transmission efficiency and a deterioration in NV characteristics, which are ascribable to inclination of the stationary sheave 152, can be suppressed. Accordingly, in this embodiment of the invention as well, an effect substantially similar to that of the foregoing embodiment of the invention can be obtained.

### Third Embodiment

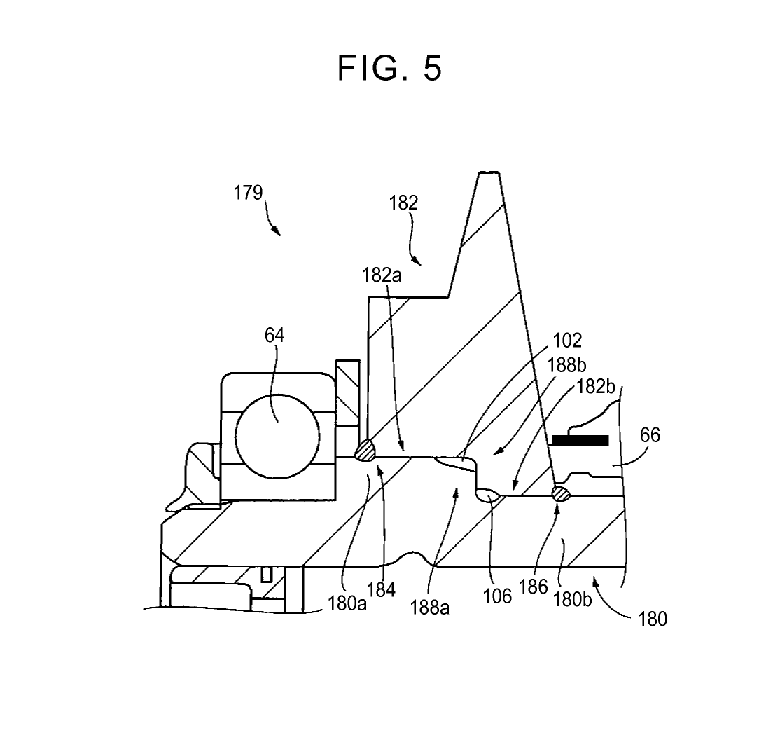

FIG. 5 is a cross-sectional view for illustrating a structure in which a stationary sheave 182 is fixed to an output shaft 180 in a secondary pulley 179 as still another embodiment of the invention. A step portion 188a is formed at an outer peripheral portion of the output shaft 180, so that a large-diameter shaft portion 180a and a small-diameter shaft portion 180b are formed. Besides, a step portion 188b that is fitted to the step portion 188a is formed also at an inner peripheral portion of the stationary sheave 182, so that a large-diameter inner peripheral portion 182a and a small-diameter inner peripheral portion 182b are formed. In this embodiment of the invention, a stationary portion of the large-diameter shaft portion 180a and the large-diameter inner peripheral portion 182a corresponds to a first stationary portion 184, and a stationary portion of the small-diameter shaft portion 180b and the small-diameter inner peripheral portion 182b corresponds to a second stationary portion 186. Incidentally, the output shaft 180 corresponds to the rotary shaft according to the invention, and the secondary pulley 179 corresponds to the pulley mechanism according to the invention.

In this embodiment of the invention, both the first stationary portion 184 and the second stationary portion 186 are fixed through welding. An end of the first stationary portion 184′ on the bearing 64 side in the axial direction is laser-welded, so that the stationary sheave 182 is integrally fixed to the output shaft 180. Besides, an end of the second stationary portion 186 on the transmission belt 66 side in the axial direction is laser-welded, so that the stationary sheave 182 is integrally fixed to the output shaft 180. That is, both inner peripheral ends of the stationary sheave 182 in the axial direction are fixed to the output shaft 180 through laser welding.

In this manner, even in the case where the first stationary portion 184 and the second stationary portion 186 are fixed through laser welding, an effect substantially similar to those of the foregoing embodiments of the invention can be obtained. That is, both the first stationary portion 184 and the second stationary portion 186 are fixed through laser welding, so that the joint strength between the output shaft 180 and the stationary sheave 182 is enhanced, and the amount of inclination of the stationary sheave 182 by the belt reaction force is also held small. Accordingly, a fall in torque capacity and transmission efficiency and a deterioration in NV performance, which are ascribable to inclination of the stationary sheave 182, are also suppressed. Besides, the first, stationary portion 184 and the second stationary portion 186 receive and hold this belt reaction force, and a bending load resulting from the belt reaction force is unlikely to be input to the step portion 188a of the output shaft 180, which is sandwiched by this first stationary portion 184 and this second stationary portion 186. Accordingly, stress concentration is also restrained from being caused at the step portion 188a of the output shaft 180.

As described above, in this embodiment of the invention, the first stationary portion 184 and the second stationary portion 186 are fixed through laser welding. In this manner, the joint strength between the output shaft 180 and the stationary sheave 182 is enhanced, and the belt reaction force is received by a welded portion of the first stationary portion 184 and a welded portion of the second stationary portion 186. Therefore, the amount of inclination of the stationary sheave 182 during power transmission is also held small, and a fall in torque capacity and transmission efficiency and a deterioration in NV characteristics can be suppressed. Accordingly, in this embodiment of the invention as well, an effect substantially similar to those of the foregoing embodiments of the invention can be obtained.

Although the embodiments of the invention have been described above in detail on the basis of the drawings, the invention is also applied to other aspects.

For example, the foregoing respective embodiments of the invention are configured independently of one another. However, the respective embodiments of the invention may be appropriately combined with one another within a compatible range and then carried out. For example, the first stationary portion is press-fitted, and the second stationary portion is laser-welded. The method of fixing the first stationary portion and the second stationary portion may be freely changed.

Besides, in each of the foregoing embodiments of the invention, neither the first stationary portion 184 nor the second stationary portion 186, which are fixed through laser welding, are spline-fitted. However, it is appropriate to adopt a configuration in which at least one of the first stationary portion 184 and the second stationary portion 186 is spline-fitted. Besides, the first stationary portion 184 and the second stationary portion 186 may be cylinder press-fitted or spline press-fitted in addition to being laser-welded.

Besides, in each of the foregoing embodiments of the invention, the large-diameter shaft portion 40a of the output shaft 40 and the large-diameter inner peripheral portion 68a of the stationary sheave 68 are spline press-fitted. However, spline press-fitting should not necessarily be limited to the large-diameter side, and the small-diameter shaft portion 40b of the output shaft 40 and the small-diameter inner peripheral portion 68b of the stationary sheave 68 may be spline press-fitted. Besides, both these shaft portions and both these inner peripheral portions may be spline press-fitted.

Besides, in each of the foregoing embodiments of the invention, the large-diameter shaft portion 40a and the large-diameter inner peripheral portion 68a adopt so-called spline large-diameter tooth flank press-fitting in which the tooth flanks of the tooth tips and tooth addendums of the outer peripheral teeth 94 on the large-diameter side and the tooth flanks of the tooth bottoms and tooth roots of the inner peripheral teeth 95 are press-fitted. However, the tooth flanks of the tooth bottoms and tooth roots of the outer peripheral teeth 94 on the small-diameter side and the tooth tips and tooth addendums of the inner peripheral teeth 95 may be press-fitted. Alternatively, the entire tooth flanks of the outer peripheral teeth 94 and the entire tooth flanks of the inner peripheral teeth may be press-fitted.

Besides, in each of the foregoing embodiments of the invention, the gaps 102 and 106 are formed at the step portion 92. However, it is not indispensable to form the gaps 102 and 106. A configuration with no gap is also acceptable.

Besides, in each of the foregoing embodiments of the invention, the example of the secondary pulley 62 has been described. However, the invention is not limited to the secondary pulley 62, but may be applied to the primary pulley 58 side.

Besides, in each of the foregoing embodiments of the invention, the first stationary portion 184 and the second stationary portion 186 are fixed through laser welding. However, other welding, means, for example, gas welding, plasma welding and the like may be applied.

Incidentally, each of what is described above is absolutely one embodiment of the invention. The invention can be carried out in a mode subjected to various modifications and improvements on the basis of the knowledge of those skilled in the art.

### DESCRIPTION OF REFERENCE NUMERALS

18: VEHICULAR BELT-TYPE CONTINUOUSLY VARIABLE TRANSMISSION

40, 150, 180: OUTPUT SHAFT (ROTARY SHAFT)

62, 149, 179: SECONDARY PULLEY (PULLEY MECHANISM)

68, 152, 182: STATIONARY SHEAVE

72: MOVABLE SHEAVE

92, 158, 188: STEP PORTION

96, 154, 184: FIRST STATIONARY PORTION

98, 156, 186: SECOND STATIONARY PORTION

100, 104: CORNER PORTION

102, 106: GAP

1. A pulley mechanism of a vehicular belt-type continuously variable transmission comprising:
a stationary sheave that is securely fitted to a rotary shaft that penetrates an inner peripheral portion thereof;
a movable sheave that is non-rotatable relatively to the rotary shaft and movable relatively in an axial direction;
step portions for receiving a load in the axial direction which are formed respectively between an outer peripheral portion of the rotary shaft and the inner peripheral portion of the stationary sheave; and
a first stationary portion and a second stationary portion that fix the rotary shaft and the stationary sheave to each other and that are provided on both sides of the step portions in the axial direction respectively,
wherein the rotary shaft and the stationary sheave configured separately from each other.

2. The pulley mechanism of the vehicular belt-type continuously variable transmission according to claim 1, wherein
the first stationary portion and the second stationary portion are fixed through press-fitting.

3. The pulley mechanism of the vehicular belt-type continuously variable transmission according to claim 2, wherein
spline teeth that mesh with each other are formed on at least one of the first stationary portion and the second stationary portion, and
the spline teeth are press-fitted to each other.

4. The pulley mechanism of the vehicular belt-type continuously variable transmission according to claim 1, wherein
the first stationary portion and the second stationary portion are fixed through welding.

5. The pulley mechanism of the vehicular belt-type continuously variable transmission according to claim 1, wherein
a gap is formed in a corner portion of at least one of the step portions that are formed on the rotary shaft and the stationary sheave.
